(19) United States
(12) Patent Application Publication
(10) Pub. No.: US 2018/0267463 A1
(43) Pub. Date: Sep. 20, 2018

(54) ADDRESSING METHOD OF SPATIAL LIGHT MODULATOR, HOLOGRAPHIC DISPLAY DEVICE AND CONTROL METHOD THEREOF

(71) Applicant: Beijing Guozhi Patent Warning Consulting Co., Ltd., Beijing (CN)

(72) Inventor: Hao CHEN, Beijing (CN)

(21) Appl. No.: 15/921,808

(22) Filed: Mar. 15, 2018

(30) Foreign Application Priority Data
Mar. 17, 2017 (CN) 201710164953.5

(51) Int. Cl. G03H 1/02; G03B 21/00

(52) U.S. Cl. CPC G03H 1/02; G03B 21/005; G02F 1/13; G03H 2001/0224; H04N 13/04

(57) ABSTRACT

An addressing method of a spatial light modulator, a holographic display device and a control method thereof is disclosed and relates to the field of display technology. The methods and device can simplify the addressing process of the spatial light modulator. The addressing method of the spatial light modulator includes the steps of: first dividing the spatial light modulator to obtain a plurality of modulation regions, each of the modulation regions including a plurality of pixel units; and then addressing one modulation region within a frame so as to load holographic data of a frame of a hologram to all the pixel units of the current modulation region.

### RELATED APPLICATIONS

The present application claims the benefit of Chinese Patent Application No. 201710164953.5, filed on Mar. 17, 2017, the entire disclosure of which is incorporated herein by reference.

### TECHNICAL FIELD

The present disclosure relates to the field of display technology, and more particular to an addressing method of a spatial light modulator, a holographic display device and a control method thereof.

### BACKGROUND ART

With the increasing popularity and use of 3D display technology, holographic display technology has gradually entered into people's lives and work. Different from parallax stereoscopic display technology, holographic display technology has many advantages, for example, it has a large depth of field and will not cause dizziness.

Traditional holographic display technology is related to optical holography based on the principles of light interference and diffraction. As shown in FIG. 1, lights emitted from a laser 21 are divided into two beams. One light beam is irradiated to an object 22, and reflected and scattered light from the surface of the object 22 reaches a holographic dry plate 23 to form an object light wave A. The other light beam that is coherent with the object light wave A is irradiated as a reference wave B to the holographic dry plate 23 to expose the holographic dry plate 23, so as to record the information on phase and amplitude of the object light wave A in the form of interference fringes on the holographic dry plate 23. Then, according to the principle of light wave diffraction, the light that is coherent with the object light wave A is irradiated onto the holographic dry plate 23 having the interference fringes to reproduce the original object light wave A to form a 3D image of the object 22.

However, since the holographic dry plate 23 is provided with a photosensitive material, the interference fringes recorded on the holographic dry plate 23 after being exposed cannot be changed, so that it is difficult to achieve dynamic display. Thus, for the sake of addressing the above problem, the computer generated hologram (CGH) technology can be used, wherein the CGH technology is to directly input the mathematical description function of the object light wave A into a computer to simulate the actual interference process, thereby calculating interference fringes and drawing a calculated hologram. Then, the computer loads the calculated hologram to every pixel of a spatial light modulator (SLM) by means of optical addressing or electric addressing so as to reproduce the calculated hologram in an actual optical path.

### SUMMARY

According to one aspect of the present disclosure, there is provided an addressing method of a spatial light modulator. The addressing method comprises the steps of: dividing the spatial light modulator to obtain a plurality of modulation regions, each of the modulation regions comprising a plurality of pixel units; and addressing one modulation region within a frame so as to load holographic data of a frame of a hologram to all the pixel units of the current modulation region.

In an embodiment, before the step of addressing one modulation region, the addressing method further comprises the steps of: obtaining a plurality of continuous frames of the hologram by means of holographic computation; according to the display order of the plurality of frames of the hologram, sorting the addressing orders of all the modulation regions so as to make at least a portion of the plurality of frames of the hologram correspond to the modulation regions respectively in a one-to-one relationship, such that one frame of the hologram corresponds to one of the modulation regions; and according to the sorting result, obtaining the current modulation region. The step of addressing one modulation region comprises the step of addressing the current modulation region so as to load the homographic data of the frame of the hologram corresponding to the current modulation region to all the pixel units of the current modulation region.

In an embodiment, any two modulations regions of the spatial light modulator have an equal number of pixel units.

In an embodiment, any two modulations regions of the spatial light modulator have the same shape.

According to another aspect of the present disclosure, there is provided a control method of a holographic display device, comprising any addressing method of a spatial light modulator as stated above. The control method further comprises the step of providing a read-out light for the spatial light modulator.

In an embodiment, after the step of obtaining the current modulation region, the step of providing a read-out light for the spatial light modulator comprises the step of providing a read-out light only for the current modulation region.

In an embodiment, after the step of obtaining the current modulation region, the control method further comprises the step of obtaining an observation position, and deflecting an output light of the current modulation region to the observation position; or deflecting the output light of the current modulation region to a middle observation area of the holographic display device.

In an embodiment, the step of deflecting an output light of the current modulation region to the observation position comprises the step of only transmitting 1-level diffracted waves in the output light of the current modulation region, and deflecting the 1-level diffracted waves to the observation position.

According to a further aspect of the present disclosure, there is provided a holographic display device. The holographic display device may comprise a spatial light modulator, the spatial light modulator comprising a plurality of modulation regions with each comprising a plurality of pixel units; and a controller connected with the spatial light modulator, and the controller being configured to address one modulation region within a frame so as to load the holographic data of the frame of the hologram to all the pixel units of the one modulation region.

In an embodiment, the holographic display device may also comprise an acquiring element and a plurality of light deflecting elements. The light deflecting elements are disposed at the light-emitting side of the spatial light modulator and correspond to the modulation regions in a one-to-one relationship. The acquiring element is connected with the controller and can be configured to acquire an observation position and output the acquiring result to the controller. Any one of the light deflecting elements is connected with the controller, and the light deflecting element can be configured to, under the control of the controller, deflect the output light of the modulation region positionally corresponding to the light deflecting element to the observation position; or deflect the output light of the modulation region positionally corresponding to the light deflecting element to a middle observation area of the holographic display device.

In an embodiment, the holographic display device may also comprise a light source unit disposed at a light-incident side of the spatial light modulator, and the light source unit may be configured to provide a read-out light for the spatial light modulator.

In an embodiment, the light source unit may comprise a plurality of light source assemblies, and the light source assemblies may correspond to the modulation regions in a one-to-one relationship. The light source assembly may be connected with the controller and configured to, under the control of the controller, provide a read-out light only for the modulation region positionally corresponding to the light source assembly.

In an embodiment, the light source assembly may comprise a laser and a collimated beam expander disposed at a light-emitting side of the laser. Or the light source assembly may comprise an LED light source.

In an embodiment, the light deflecting element may comprise a liquid crystal grating or a light guiding element.

In an embodiment, the spatial light modulator may comprise a liquid crystal spatial light modulator.

### BRIEF DESCRIPTION OF DRAWINGS

To explain the technical solutions of some embodiments of the present disclosure more clearly, the present disclosure provides the following drawings for use when describing the embodiments. It shall be appreciated that the following drawings are only related to some embodiments. Without making inventive labor, those ordinarily skilled in the art can also obtain other drawings according to these drawings, and the other drawings are within the scope of the present disclosure.

FIG. 1 is a schematic view showing a holographic display principle according to the related art;

FIG. 2 is a flow chart of an addressing method of a spatial light modulator according to an embodiment of the present disclosure;

FIG. 3 is a schematic view showing division of the spatial light modulator in step S101 of FIG. 2;

FIG. 4 is a specific structural schematic view of a modulation region shown in FIG. 3;

FIG. 5 is a flow chart of another addressing method of a spatial light modulator according to an embodiment of the present disclosure;

FIG. 6 is another schematic view showing the division of the spatial light modulator in step S101 of FIG. 2;

FIG. 7 is a further schematic view showing the division of the spatial light modulator in step S101 of FIG. 2;

FIG. 8 shows the diffracted waves resulting from diffraction of a read-out light and interference fringes loaded to the spatial light modulator in a holographic reproduction process according to an embodiment of the present disclosure;

FIG. 9 is a structural schematic view of a holographic display device according to an embodiment of the present disclosure; and

FIG. 10 is a structural schematic view of another holographic display device according to an embodiment of the present disclosure.

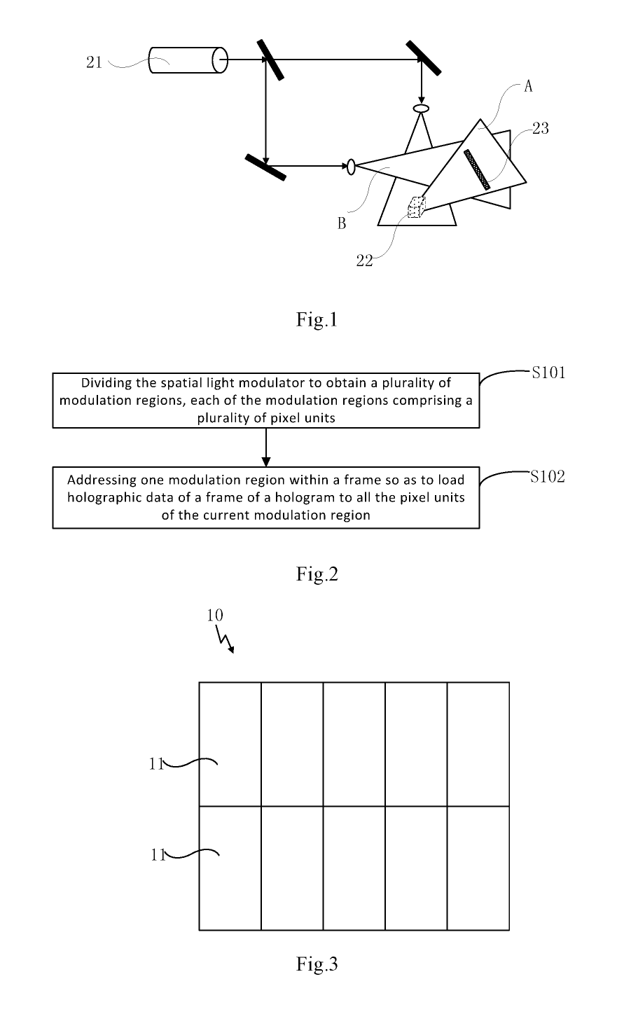

### REFERENCE SIGNS

10 Spatial light modulator; 11 Modulation region; 1101 First modulation region; 1102 Second modulation region; 1103 Third modulation region; 1104 Fourth modulation region; 20 Light source unit; 201 Light source assembly; 21 Laser; 210 Collimated beam expander; 30 Controller; 40 Light deflecting element; 50 Acquiring element; 111 Pixel unit; 22 Object; 23 Holographic dry plate; A Object light wave; and B Reference wave.

### DETAILED DESCRIPTION

The technical solutions of the embodiments in the present disclosure will be described clearly and completely with reference to the drawings of the embodiments in the present disclosure. It shall be appreciated that the embodiments described herein are merely a part, not the whole, of the embodiments of the present disclosure. On the basis of the embodiments in the present disclosure, those ordinarily skilled in the art can obtain other embodiments without making inventive labour. All the obtained other embodiments fall within the scope of the present disclosure.

Inventors of the present disclosure realize that with the development of a high-resolution spatial light modulator, the spatial light modulator usually has a pixel size in microns, so the addressing process of a computer is complicated, and requires huge data computation amount and long image loading time. Thus, when the holographic display device conducts dynamic holographic display, the image refresh rate is relatively low and the display effect is lowered.

To address or alleviate at least one defect in the prior art, according to several aspects of the present disclosure, there are provided an addressing method of a spatial light modulator, a holographic display device and a control method thereof, so as to simplify the addressing process of the spatial light modulator.

FIG. 2 is a flow chart of an addressing method of a spatial light modulator according to an embodiment of the present disclosure. As shown in FIG. 2, the method comprises S101: dividing the spatial light modulator to obtain a plurality of modulation regions with each comprising a plurality of pixel units; and S102: addressing one modulation region within a frame so as to load holographic data of a frame of a hologram to all the pixel units of the current modulation regions.

FIG. 3 is a schematic view showing division of the spatial light modulator in step S101 of FIG. 2, and FIG. 4 is a specific structural schematic view of a modulation region shown in FIG. 3. As shown in FIG. 3, the spatial light modulator 10 is divided into a plurality of modulation regions 11. As shown in FIG. 4, each of the modulation regions 11 comprises a plurality of pixel units 111.

What shall be explained is that the number of the pixel units 111 in each modulation region 11 shall be greater than or equal to the minimum number of the pixel units 111 required for the modulation region 11 to carry out holographic display alone. That is, the present disclosure imposes no limitation to the number of the plurality of pixel units 111 in each modulation region 11, as long as the holographic display can be realized by addressing a single modulation region 11, loading holographic data and performing a holographic reproduction.

In step S102, one modulation region 11 is addressed within a frame so as to load holographic data of a frame of a hologram to all the pixel units 111 of the current modulation region 11. As such, when a frame of a hologram is displayed, it is only required to address, within a frame, the pixel units 111 in one modulation region 11 of the spatial light modulator 10, rather than address all the pixel units 111 of the spatial light modulator, which can simplify the addressing process and reduce the data computation amount. Thus, when a holographic display device made of the spatial light modulator 10 is used for holographic display, it can reduce the time for loading the hologram and further increase the display image refresh rate of the holographic display device.

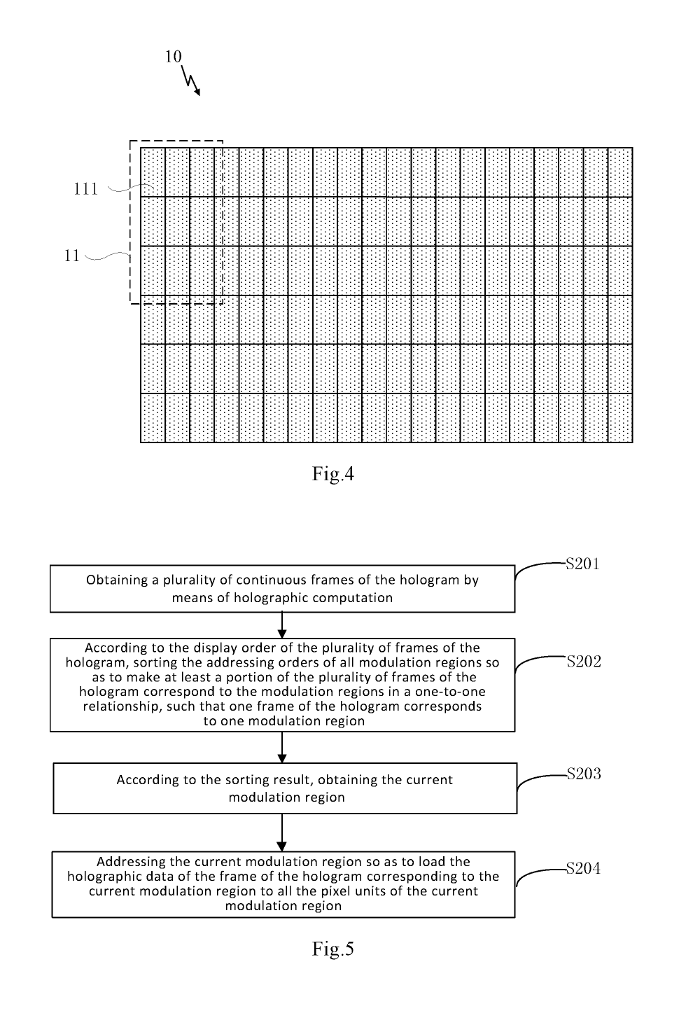

FIG. 5 is a flow chart of another addressing method of a spatial light modulator according to an embodiment of the present disclosure. In this embodiment, during the dynamic holographic display, before the step S102, the addressing orders of the plurality of modulation regions 11 can be set according to the display order of a plurality of continuous frames of the hologram, in order to facilitate control and management.

As shown in FIG. 5, the addressing method may also comprise steps S201 to S204.

In S201, a plurality of continuous frames of the hologram is obtained by means of holographic computation.

What shall be explained is that the holographic computation is to compute a hologram by a computer, and it does not need an object that actually exists, but inputs the mathematical description function of the object light wave into a computer to simulate the actual interference process, thereby calculating interference fringes and drawing a calculated hologram.

In an implementation, the process of drawing a hologram according to holographic computation may comprise the following steps:

Firstly, the values of an object or a wave surface at discrete sample points are sampled;

Then, the light field distribution of an object light wave on a holographic plane is calculated;

Then, encoding is conducted, so as to encode the complex amplitude distribution of the optical wave on the holographic plane into a transmittance change of the hologram;

Finally, a picture is drawn, i.e., the transmittance change of the hologram is drawn into a drawing under the control of a computer. If a drawing device does not have enough resolution, then a larger picture is drawn and then reduced in its size to a desired hologram.

In the process of holographic computation, the plurality of continuous frames of the hologram required for the dynamic holographic display is drawn respectively.

In S202, according to the display order of the plurality of frames of the hologram, the addressing orders of all modulation regions 11 are sorted so as to make at least a portion of the plurality of frames of the hologram correspond to the modulation regions 11 in a one-to-one relationship, such that one frame of the hologram corresponds to one modulation region 11.

What shall be explained is that the present disclosure imposes no limitation to the relationship between the number of frames of the hologram obtained in the step S201 and the total number of all the modulation regions 11 of the spatial light modulator. If resolution is a factor to be considered when calculating the manufacturing cost, the number of frames of the hologram obtained in the step S201 is usually greater than the total number of all the modulation regions 11 during the process of dynamic holographic display. Under such circumstances, since only one frame of the hologram can be loaded to each modulation region 11 within a frame, when the number of frames of the hologram obtained in the step S201 is greater than the total number of all the modulation regions 11, the addressing orders of all the modulation regions 11 can be sorted according to the display order of the plurality of frames of the hologram obtained in the step S201, and then make a portion of frames of the hologram, the number of which is the same as the total number of all the modulation regions 11, correspond to all modulation region 11 in a one-to-one relationship sequentially.

If the manner of dividing the spatial light modulator 10 in the step S101 is different, then the manner of making the hologram obtained in the step S201 correspond to the modulation regions 11 will be different, too.

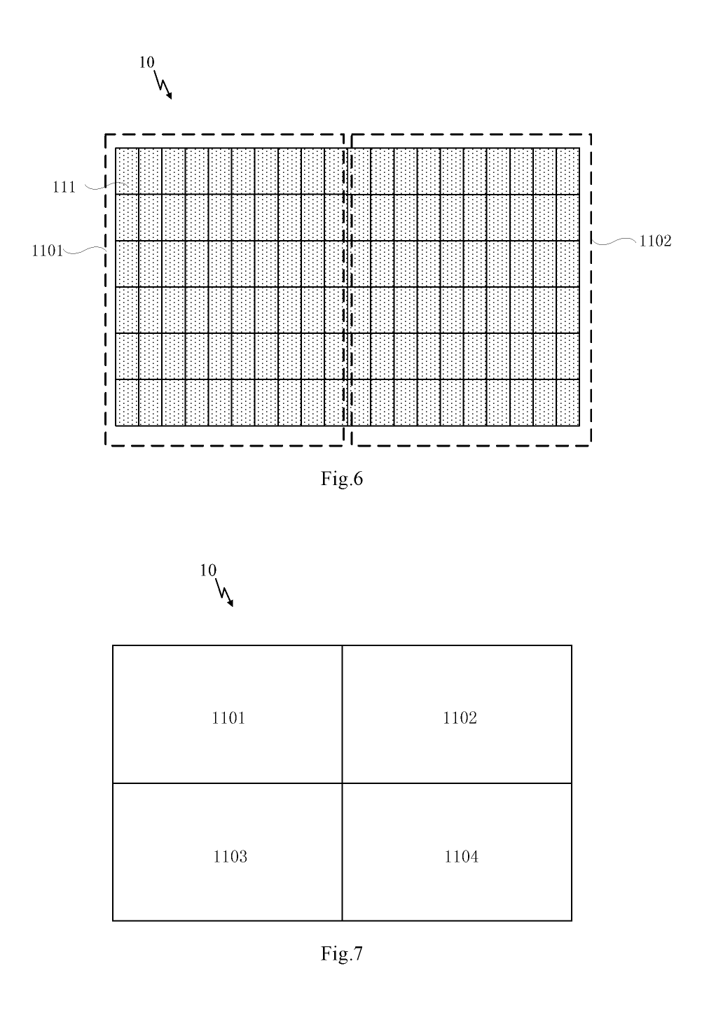

For instance, as shown in FIG. 6, the spatial light modulator 10 can be divided into two modulation regions 11, which are respectively a first modulation region 1101 and a second modulation region 1102. The first modulation region 1101 consists of rows of the pixel units 111 in the left half of the spatial light modulator 10, and the second modulation region 1102 consists of rows of the pixel units 111 in the right half of the spatial light modulator 10.

What shall be explained is that position terms herein, such as “left” and “right”, are defined with respect to the exemplary position of the spatial light modulator 10 in the drawings. It shall be understood that these position terms are relative concepts and used for relative description and clarification, and can vary accordingly with the change of the position where the spatial light modulator 10 is disposed.

For instance, where the spatial light modulator 10 is divided into two modulation regions 1101 and 1102 and continuous eight frames of the hologram are obtained in the step S201, the step S202 may further comprise the following step:

according to the display order of the plurality of frames of the hologram, the addressing orders of all the modulation regions 11 are that: first, the first modulation region 1101 is addressed; then, the second modulation region 1102 is addressed; and next, the above addressing orders are repeated so as to make the first frame of the hologram and the second frame of the hologram respectively correspond to the first modulation region 1101 and the second modulation region 1102, such that the holographic data of the first frame of the hologram can be loaded to the first modulation region 1101, and the holographic data of the second frame of the hologram be loaded to the second modulation region 1102. Next, the above steps are repeated to make the following frames of the hologram respectively correspond to the modulation regions, such that the first modulation region 1101 can correspond to odd frames (or even frames) of the hologram, and the second modulation region 1102 can correspond to even frames (or odd frames) of the hologram.

For another example, as shown in FIG. 7, the spatial light modulator 10 is divided into four modulation regions 11, which are respectively a first modulation region 1101, a second modulation region 1102, a third modulation region 1103 and a fourth modulation region 1104. Under such circumstances, take the continuous eight frames of the hologram obtained in the step S201 for example, the step S202 can further comprise the following step:

according to the display order of the plurality of frames of the hologram, the addressing orders of all the modulation regions 11 are sequentially the first modulation region 1101, the second modulation region 1102, the third modulation region 1103 and the fourth modulation region 1104; then, the above addressing orders are repeated so as to make the first frame of the hologram, the second frame of the hologram, the third frame of the hologram and the fourth frame of the hologram correspond to the first modulation region 1101, the second modulation region 1102, the third modulation region 1103 and the fourth modulation region 1104 respectively, such that the holographic data of the first frame of the hologram can be loaded to the first modulation region 1101, the holographic data of the second frame of the hologram can be loaded to the second modulation region 1102, the holographic data of the third frame of the hologram can be loaded to the third modulation region 1103, and the holographic data of the fourth frame of the hologram can be loaded to the fourth modulation region 1104. Then, the above steps are repeated so as to make the fifth frame of the hologram, the sixth frame of the hologram, the seventh frame of the hologram and the eighth frame of the hologram correspond to the first modulation region 1101, the second modulation region 1102, the third modulation region 1103 and the fourth modulation region 1104 respectively, such that the holographic data of the fifth frame of the hologram can be loaded to the first modulation region 1101, the holographic data of the sixth frame of the hologram can be loaded to the second modulation region 1102, the holographic data of the seventh frame of the hologram can be loaded to the third modulation region 1103, and the holographic data of the eighth frame of the hologram can be loaded to the fourth modulation region 1104.

Of course, the above explanation is made by taking for example the continuous eight frames of the hologram obtained in the step S201, and two modulation regions 11 or four modulation regions 11 obtained by dividing the spatial light modulator 10. If the number of the holograms obtained in the step S201 varies and the number of divided modulation regions 11 varies, the manner of making all the modulation regions 11 correspond to the plurality of frames of the hologram may be the one similar to the above manner, which will not be reiterated.

When a holographic display device with the spatial light modulator is used for holographic display, any two adjacent frames of hologram have the same resolution in order to improve the display effect. Thus, the spatial light modulator 10 can be divided in such a way that, as shown in FIG. 6, any two modulations regions 11 of the spatial light modulator 10 have an equal number of pixel units 111.

In addition, for making the reproduced hologram compatible with viewing habits and display data, the spatial light modulator 10 can be divided in such a way that, as shown in FIG. 7, any two modulation regions of the spatial light modulator 10 have the same shape, e.g., both are in a rectangular shape.

In S203, according to the sorting result, the current modulation region is obtained.

For example, if the manner of dividing the spatial light modulator 10 is the one shown in FIG. 6 or 7, when the first frame of the hologram needs to be displayed, since the first frame of the hologram corresponds to the first modulation region 1101, the first modulation region 1101 is the current modulation region.

When the third frame of the hologram needs to be displayed, if the manner of dividing the spatial light modulator 10 is the one shown in FIG. 6, since the third frame of the hologram corresponds to the first modulation region 1101, the first modulation region 1101 is the current modulation region. If the manner of dividing the spatial light modulator 10 is the one shown in FIG. 7, since the third frame of the hologram corresponds to the third modulation region 1103, the third modulation region 1103 is the current modulation region.

In S204, the current modulation region is addressed so as to load the holographic data of the frame of the hologram corresponding to the current modulation region to all the pixel units 111 of the current modulation region. What shall be explained is that the step S204 in FIG. 5 corresponds to the step S102 in FIG. 2.

If the manner of dividing the spatial light modulator 10 is the one shown in FIG. 6, when the first modulation region 1101 is the current modulation region, the holographic data of odd frames (or even frames) of the hologram are sequentially loaded to all the pixel units 111 of the first modulation region 1101 according to the display order. At this time, the loaded hologram can be reproduced by enabling the rows of the pixel units 111 in the left half of the spatial light modulator 10 to display images, and the rows of the pixel units 111 in the right half that do not display images are placed in a to-be-loaded state. In addition, when the second modulation region 1102 is the current modulation region, the holographic data of even frames (or odd frames) of the hologram are sequentially loaded to all the pixel units 111 in the second modulation region 1102 according to the display order. At this time, the loaded hologram can be reproduced by enabling the rows of the pixel units 111 in the right half of the spatial light modulator 10 to display images, and the rows of the pixel units 111 in the left half that do not display images are placed in a to-be-loaded state. In doing so, the rows of the pixel units 111 in the left half and the rows of the pixel units 111 in the right half of the spatial light modulator 10 can load the holographic data of two adjacent frames of the hologram alternately by means of alternate addressing, so as to dynamically display the plurality of continuous frames of the hologram. Since, within each frame, there is only one modulation region 11 in the spatial light modulator 10, i.e. the current modulation region, that is addressed, the addressing process can be simplified and the data computation amount be reduced.

If the manner of dividing the spatial light modulator 10 is the one shown in FIG. 7, take the continuous eight frames of the hologram obtained in the step S201 for example, when the first modulation region 1101 is the current modulation region, the holographic data of the first frame of the hologram or the fifth frame of the hologram are loaded to all the pixel units 111 of the first modulation region 1101; when the second modulation region 1102 is the current modulation region, the holographic data of the second frame of the hologram or the sixth frame of the hologram are loaded to all the pixel units 111 of the second modulation region 1102; when the third modulation region 1103 is the current modulation region, the holographic data of the third frame of the hologram or the seventh frame of the hologram are loaded to all the pixel units 111 of the third modulation region 1103; and when the fourth modulation region 1104 is the current modulation region, the holographic data of the fourth frame of the hologram or the eighth frame of the hologram are loaded to all the pixel units 111 of the fourth modulation region 1104. Then, when the current modulation region loaded with the hologram is reproduced, all the pixel units 111 in the current modulation region of the modulation regions 11 are used to display, and the pixel units 111 in other modulation regions are in a to-be-loaded state. In this manner, the first modulation region 1101, the second modulation region 1102, the third modulation region 1103 and the fourth modulation region 1104 display the first frame of the hologram, the second frame of the hologram, the third frame of the hologram and the fourth frame of the hologram sequentially, and then the first modulation region 1101, the second modulation region 1102, the third modulation region 1103 and the fourth modulation region 1104 again display the fifth frame of the hologram, the sixth frame of the hologram, the seventh frame of the hologram and the eighth frame of the hologram sequentially so as to dynamically display the plurality of continuous frames of the hologram. Since, within each frame, there is only one modulation region 11 in the spatial light modulator 10, i.e. the current modulation region, that is addressed, the addressing process can be simplified and the data computation amount be reduced.

According to another aspect of the present disclosure, there is provided a control method of a holographic display device, which comprises any addressing method of the spatial light modulator as stated above. The control method may further comprise the step of providing a read-out light for the spatial light modulator 10. Thus, the read-out light can be diffracted by the interference fringes loaded to the spatial light modulator to reproduce the hologram and form a 3D image. The control method of the holographic display device has the same advantageous effects as the addressing method of the spatial light modulator, which will not be reiterated herein.

In an embodiment, for the sake of reducing power consumption, after the current modulation region is obtained, only the current modulation region is provided with a read-out light. In an implementation, separate light source assemblies for providing a read-out light can be disposed in positions corresponding to different modulation regions 11, in such a way that, after the current modulation region is determined, only the light source assembly positionally corresponding to the current modulation region is turned on, and the rest light source assemblies are in an off state, which can achieve the purpose of reducing power consumption.

In addition, since, during the display process of the holographic display device, it is only required to address the pixel units 111 in one modulation region of the spatial light modulator 10 within each frame so as to enable the portion of the pixel units 111 to display images, a user who is viewing a hologram may not be in the best observation position for the current modulation region, thus failing to allow the output light of the current modulation region to enter into the observer's eyes to the maximum extent. Hence, in order to improve the display effect, in an embodiment, after obtaining the current modulation region, the control method may also comprise:

First, an observation position is obtained. For instance, the positions of an observer's body, head, eyes or pupils can be obtained as the observation position by a camera.

Then, the output light of the current modulation region is deflected to the observation position, so that the output light of the current modulation region can enter into the observer's eyes to the maximum extent, thereby improving the observer's viewing effect.

Or alternatively, there is no need to obtain the observation position, but the output light of the current modulation region shall be directly deflected to the middle observation area of the holographic display device. The middle observation area corresponds to the central position of the holographic display device, which is usually the best observation position of the holographic display device.

The diffracted waves resulting from diffraction of the read-out light and interference fringes loaded to the spatial light modulator 10 may, as shown in FIG. 8, have multiple diffraction levels, wherein 0-level diffraction waves and ±2-level or higher level diffraction waves have smaller strength, and ±1-level diffraction waves have larger strength. Thus, the step of deflecting the output light of the current modulation region to the observation position comprises the step of only transmitting the 1-level (i.e., +1-level or −1-level) diffraction waves in the output light of the current modulation region, and deflecting the 1-level diffraction waves to the observation position. Thus, the observer in the observation position can observe the best hologram.

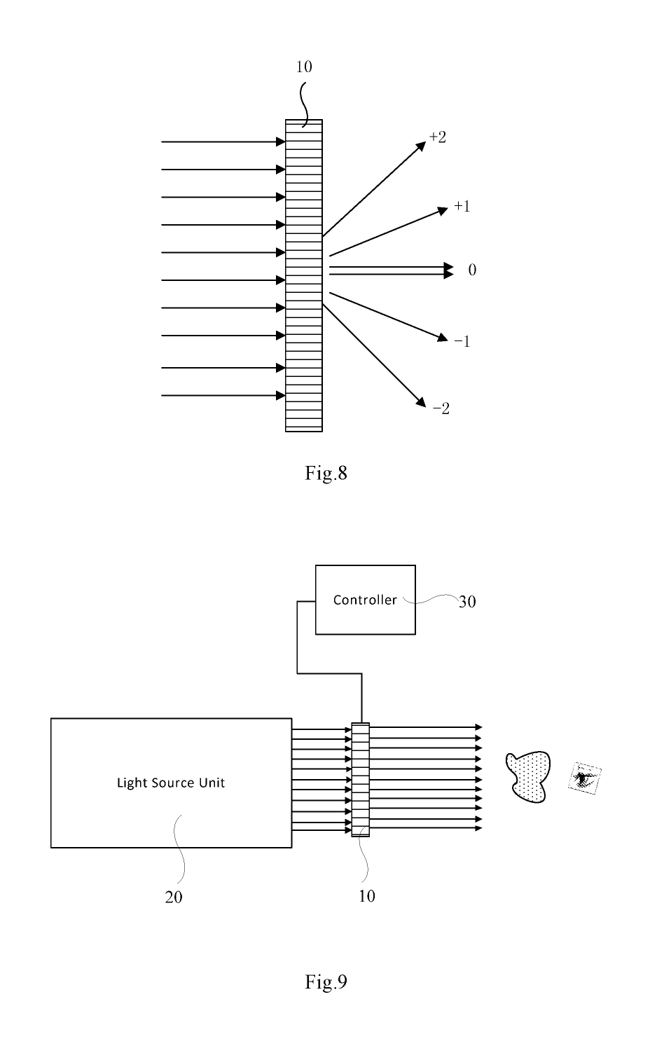

According to another aspect of the present disclosure, there is provided a holographic display device. FIG. 9 is a structural schematic view of the holographic display device. As shown in FIG. 9, the holographic display device may comprise a spatial light modulator 10, the spatial light modulator 10 may comprise a plurality of modulation regions 11 as shown in FIG. 3, and each modulation region 11 may comprise a plurality of pixel units 111 as shown in FIG. 4.

In an embodiment, the spatial light modulator 10 may comprise a liquid crystal spatial light modulator.

Moreover, the holographic display device may also comprise a controller 30 connected with the spatial light modulator 10, and the controller 30 may be configured to address one modulation region 11 within a frame so as to load the holographic data of the frame of the hologram to all the pixel units 111 of the one modulation regions 11.

Thus, when a frame of a hologram is displayed, it is only required to address the pixel units 111 in one modulation region 11 of the spatial light modulator 10, rather than address all the pixel units 111 of the spatial light modulator, which can simplify the addressing process and reduce the data computation amount. Thus, when a holographic display device made of the spatial light modulator 10 is used for holographic display, it can reduce the time for loading the hologram and further increase the display image refresh rate of the holographic display device.

In order to provide a read-out light for the spatial light modulator 10, the holographic display device, as shown in FIG. 9, may also comprise a light source unit 20 disposed at a light-incident side of the spatial light modulator 10, and the light source unit 20 may be configured to provide a read-out light for the spatial light modulator 10.

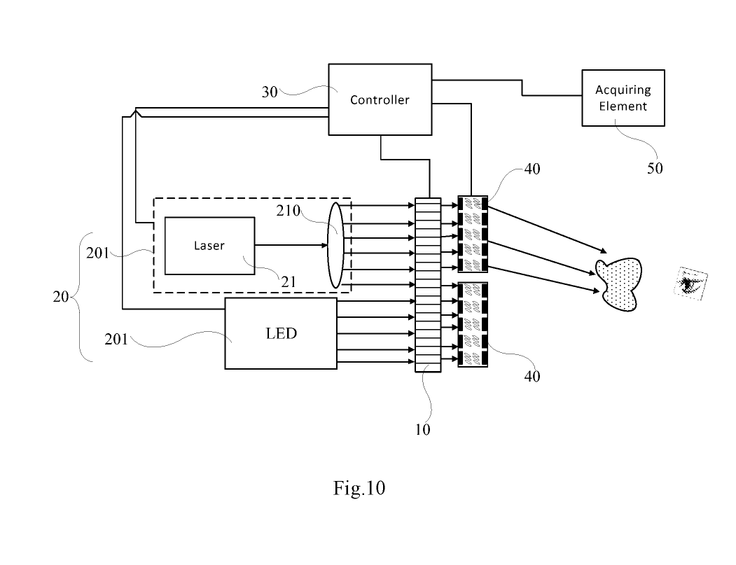

FIG. 10 is a structural schematic view of another holographic display device according to an embodiment of the present disclosure. As shown in FIG. 10, in the embodiment, in order to reduce power consumption, the light source unit 20 may comprise a plurality of light source assemblies 201, wherein the light source assemblies 201 correspond to the modulation regions 11 in a one-to-one relationship, i.e., an independently-switched light source assembly 201 is disposed correspondingly in the light-incident side of each modulation region 11. Any one of the light source assemblies 201 can be connected with the controller 30, and the light source assembly 201 can be configured to provide a read-out light only for the modulation region 11 positionally corresponding to the light source assembly 201 under the control of the controller 30. Thus, after the current modulation region is determined, only the light source assembly 201 positionally corresponding to the current modulation region is turned on, and the rest light source assemblies 201 are in an off state, which can achieve the purpose of reducing the power consumption.

In an embodiment, the light source assembly 20 may comprise a laser 21 and a collimated beam expander 210 disposed at a light-emitting side of the laser 21. The collimated beam expander 201 may convert a linear light source emitted by the laser 21 into a collimated area light source.

Alternatively, the light source assembly 20 may also comprise, as shown in FIG. 10, an LED light source, which can emit white light.

Furthermore, since, during the display process of the holographic display device, it is only required to address the pixel units 111 in one modulation region of the spatial light modulator 10 within each frame so as to enable the portion of the pixel units 111 to display images, a user who is viewing a hologram may not be in the best observation position for the current modulation region, thus failing to allow the output light of the current modulation region to enter into the observer's eyes to the maximum extent.

Hence, in an embodiment, in order to improve the display effect, as shown in FIG. 10, the holographic display device may also comprise an acquiring element 50 and a plurality of light deflecting elements 40, the light deflecting elements 40 are disposed at the light-emitting side of the spatial light modulator 10 and correspond to the modulation regions 11 in a one-to-one relationship.

The acquiring element 50 is connected with the controller 30 and may be configured to acquire the observation position of the observer and output the acquiring result to the controller 30. The acquiring element 50 may be a camera, which acquires the positions of the observer's body, head, eyes or pupils to obtain the observation position.

Further, any one of the light deflecting elements 40 is connected with the controller 30, and the light deflecting element 40 may be configured to, under the control of the controller 30, deflect the output light of the modulation region 11 positionally corresponding to the light deflecting element 40 to the observation position, so that the output light of the current modulation region can enter into the observer's eyes to the maximum extent, thereby improving the observer's viewing effect.

Or alternatively, there is no need to obtain the observation position, but the output light of the modulation region 11 positionally corresponding to the light deflecting element 40 shall be directly deflected by the light deflecting element 40 to the middle observation area of the holographic display device.

In an embodiment, the light deflecting element 40 may comprise a liquid crystal grating. The liquid crystal grating is provided therein with a liquid crystal layer, at both sides of which is there a block electrode. The voltage input to the block electrode can control the deflection angle of liquid crystal molecules in the liquid crystal layer and further control the emitting direction of the output light of the modulation region 11 positionally corresponding to the liquid crystal grating as required. Or alternatively, the light deflecting element may comprise a light guiding element, e.g., the light guiding element may consist of a plurality of optical lenses and/or thin films.

In some embodiments of the present disclosure, the addressing method of the spatial light modulator comprises the steps of: first dividing the spatial light modulator to obtain a plurality of modulation regions, each of the modulation regions comprising a plurality of pixel units; and then addressing one modulation region within a frame so as to load holographic data of a frame of a hologram to all the pixel units of the current modulation region. As such, when a frame of a hologram is displayed, it is only required to address the pixel units in one modulation region of the spatial light modulator, rather than address all the pixel units of the spatial light modulator, which can simplify the addressing process and reduce the data computation amount. Thus, when a holographic display device made of the spatial light modulator is used for holographic display, it can reduce the time for loading the hologram and further increase the display image refresh rate of the holographic display device.

It can be understood that the above embodiments are only exemplary embodiments of the present disclosure, but the protection scope of the present disclosure is not limited thereto. It shall be pointed out that those ordinarily skilled in the art can readily conceive of various variations or replacements without departing from the spirit and principle of the present disclosure. These variations or replacements will fall within the protection scope of the present disclosure. The protection scope of the present disclosure shall be based on the protection scope of the appended claims.

What shall be explained is that the above embodiments are only illustrated by way of the individual function modules division. In actual application, the above functions can be allocated to different functional modules as desired. The internal structure of the device can be divided into different functional modules so as to accomplish all or part of the functions as stated above. In addition, function(s) of the above one module can be achieved by a plurality of modules, and functions of the plurality of modules can be integrated into one module.

In the claims, any reference sign in parentheses should not be interpreted as a limitation to the claims. The term “comprise/include” does not exclude the presence of elements or steps other than those listed in the claims. The word “a” or “an” in front of elements does not exclude the presence of a plurality of such elements.

In device or system claims that enumerate several means, one or more of the means can be embodied in one and the same item of hardware. The mere fact that some measures are recited in dependent claims that are different from each other does not indicate that the combination of the measures cannot be used to advantage.

What is claimed is:

1. An addressing method of a spatial light modulator, comprising the steps of:
dividing the spatial light modulator to obtain a plurality of modulation regions, each of the modulation regions comprising a plurality of pixel units; and
addressing one modulation region within a frame so as to load holographic data of a frame of a hologram to all the pixel units of the current modulation region.

2. The addressing method of a spatial light modulator according to claim 1, wherein before the step of addressing one modulation region, the addressing method further comprises the steps of:
obtaining a plurality of continuous frames of the hologram by means of holographic computation;
according to the display order of the plurality of frames of the hologram, sorting the addressing orders of all the modulation regions so as to make at least a portion of the plurality of frames of the hologram correspond to the plurality of modulation regions respectively in a one-to-one relationship, such that one frame of the hologram corresponds to one of the modulation regions; and
according to the sorting result, obtaining the current modulation region,
the step of addressing one modulation region comprises the step of addressing the current modulation region so as to load the homographic data of the frame of the hologram corresponding to the current modulation region to all the pixel units of the current modulation region.

3. The addressing method of a spatial light modulator according to claim 1, wherein any two modulations regions of the spatial light modulator have an equal number of pixel units.

4. The addressing method of a spatial light modulator according to claim 1, wherein any two modulations regions of the spatial light modulator have the same shape.

5. A control method of a holographic display device, comprising the addressing method of a spatial light modulator according to claim 1, the control method further comprising the step of
providing a read-out light for the spatial light modulator.

6. The control method of a holographic display device according to claim 5, wherein
after the step of obtaining the current modulation region, the step of providing a read-out light for the spatial light modulator comprises the step of providing a read-out light only for the current modulation region.

7. The control method of a holographic display device according to claim 5, wherein after the step of obtaining the current modulation region, the control method further comprises the step of
obtaining an observation position, and deflecting an output light of the current modulation region to the observation position; or
deflecting the output light of the current modulation region to a middle observation area of the holographic display device.

8. The control method of a holographic display device according to claim 7, wherein the step of deflecting an output light of the current modulation region to the observation position comprises the step of
only transmitting 1-level diffracted waves in the output light of the current modulation region, and deflecting the 1-level diffracted waves to the observation position.

9. A holographic display device, comprising:
a spatial light modulator, the spatial light modulator comprising a plurality of modulation regions with each comprising a plurality of pixel units; and
a controller connected with the spatial light modulator, and the controller being configured to address one modulation region within a frame so as to load the holographic data of the frame of the hologram to all the pixel units of the one modulation region.

10. The holographic display device according to claim 9, further comprising an acquiring element and a plurality of light deflecting elements, the light deflecting elements being disposed at the light-emitting side of the spatial light modulator and corresponding to the modulation regions in a one-to-one relationship;
the acquiring element being connected with the controller and configured to acquire an observation position and output the acquiring result to the controller;
any one of the light deflecting elements being connected with the controller, and the light deflecting element being configured to, under the control of the controller,
deflect the output light of the modulation region positionally corresponding to the light deflecting element to the observation position; or
deflect the output light of the modulation region positionally corresponding to the light deflecting element to a middle observation area of the holographic display device.

11. The holographic display device according to claim 9, further comprising a light source unit disposed at a light-incident side of the spatial light modulator, and the light source unit being configured to provide a read-out light for the spatial light modulator.

12. The holographic display device according to claim 11, wherein the light source unit comprises a plurality of light source assemblies, and the light source assemblies correspond to the modulation regions in a one-to-one relationship;
the light source assembly is connected with the controller and configured to, under the control of the controller, provide a read-out light only for the modulation region positionally corresponding to the light source assembly.

13. The holographic display device according to claim 12, wherein the light source assembly comprises a laser and a collimated beam expander disposed at a light-emitting side of the laser; or
the light source assembly comprises an LED light source.

14. The holographic display device according to claim 10, wherein the light deflecting element comprises a liquid crystal grating or a light guiding element.

15. The holographic display device according to claim 9, wherein the spatial light modulator may comprise a liquid crystal spatial light modulator.
